(19) United States
(12) Patent Application Publication
(10) Pub. No.: US 2026/0188993 A1
(43) Pub. Date: Jul. 2, 2026

(54) CABLE ASSEMBLY WITH SPLICE CONNECTOR

(71) Applicant: TE Connectivity Solutions GmbH, Schaffhausen (CH)

(72) Inventors: Jared Evan Rossman, Middletown, PA (US); Brian Patrick Costello, Fremont, CA (US); Jason Ellison, Middletown, PA (US)

(21) Appl. No.: 19/007,906

(22) Filed: Jan. 2, 2025

(51) Int. Cl. H02G 15/117; H02G 15/113

(52) U.S. Cl. CPC H02G 15/117; H02G 15/113

(57) ABSTRACT

A cable assembly is provided and includes a primary twinaxial cable that includes a first conductor and a second conductor. The primary twinaxial cable includes a primary insulator holding the first and second conductors of the primary twinaxial cable. Exposed portions of the first and second conductors of the primary twinaxial cable protrude from the primary insulator. The primary twinaxial cable includes a primary cable shield surrounding the primary insulator to provide shielding for the first and second conductors of the primary twinaxial cable. The cable assembly includes a secondary twinaxial cable that includes a first conductor and a second conductor.

### BACKGROUND OF THE INVENTION

The subject matter herein relates generally to cable assemblies.

Electrical cables and connectors are used to transmit data in various industries. The electrical cables span the distance between the electrical devices to provide electrical paths between the electrical devices. The electrical connectors terminate the electrical cables and mate with complementary connectors of the electrical devices to interconnect the electrical devices via the electrical pathways provided by cables.

The termination interface of some connectors where the connector terminates multiple cables may have a relatively high density of electrical connections and therefore a relatively tight grouping of the cables, for example because of the small form factor and/or number of signal paths of many contemporary connectors. The termination interface of some connectors therefore may only accommodate electrical cables up to a certain diameter in size. In other words, the termination interface of some connectors may only accommodate relatively small diameter cables. But, such small diameter cables may not be suitable for spanning some distances between electrical devices because of the loss rate of the small diameter cable. Specifically, the loss rate for cables that have a sufficiently small diameter to fit within the termination interface of the connector may be unacceptably high. Conversely, larger diameter cables that have acceptable loss rates for the given distance between the electrical devices are too large to be grouped within the termination interface of the connector.

Accordingly, a need remains for a lower loss electrical cable that can be terminated to a connector having a termination interface with a relatively high density of electrical connections.

### BRIEF DESCRIPTION OF THE INVENTION

In one embodiment, a cable assembly is provided and includes a primary twinaxial cable that includes a first conductor and a second conductor. The primary twinaxial cable includes a primary insulator holding the first and second conductors of the primary twinaxial cable. Exposed portions of the first and second conductors of the primary twinaxial cable protrude from the primary insulator. The primary twinaxial cable includes a primary cable shield surrounding the primary insulator to provide shielding for the first and second conductors of the primary twinaxial cable. The cable assembly includes a secondary twinaxial cable that includes a first conductor and a second conductor. The secondary twinaxial cable includes a secondary insulator holding the first and second conductors of the secondary twinaxial cable. Exposed portions of the first and second conductors of the secondary twinaxial cable protrude from the secondary insulator. The secondary twinaxial cable includes a secondary cable shield surrounding the secondary insulator to provide shielding for the first and second conductors of the secondary twinaxial cable. The cable assembly includes a splice connector between the primary twinaxial cable and the secondary twinaxial cable to electrically connect the first and second conductors of the primary twinaxial cable with the first and second conductors of the secondary twinaxial cable. The splice connector includes an outer shell having a primary shroud forming a primary cavity receiving an end of the primary twinaxial cable, a secondary shroud forming a secondary cavity receiving an end of the secondary twinaxial cable, and a splice shroud forming a splice cavity receiving the exposed portions of the first and second conductors of the primary and secondary twinaxial cables. The first and second conductors of the primary twinaxial cable are electrically connected with the first and second conductors of the secondary twinaxial cable in the splice cavity. The outer shell is electrically conductive. The primary shroud is electrically connected to the primary cable shield. The secondary shroud is electrically connected to the secondary cable shield.

In another embodiment, a cable assembly is provided and includes a primary twinaxial cable that includes a first conductor and a second conductor. The primary twinaxial cable includes a primary insulator holding the first and second conductors of the primary twinaxial cable. Exposed portions of the first and second conductors of the primary twinaxial cable protrude from the primary insulator. The primary twinaxial cable includes a primary cable shield surrounding the primary insulator to provide shielding for the first and second conductors of the primary twinaxial cable. The cable assembly includes a secondary twinaxial cable that includes a first conductor and a second conductor. The secondary twinaxial cable includes a secondary insulator holding the first and second conductors of the secondary twinaxial cable. Exposed portions of the first and second conductors of the secondary twinaxial cable protrude from the secondary insulator. The secondary twinaxial cable includes a secondary cable shield surrounding the secondary insulator to provide shielding for the first and second conductors of the secondary twinaxial cable. The cable assembly includes a splice connector between the primary twinaxial cable and the secondary twinaxial cable to electrically connect the first and second conductors of the primary twinaxial cable with the first and second conductors of the secondary twinaxial cable. The splice connector includes a splice holder receiving and holding the exposed portions of the first and second conductors of the primary and secondary twinaxial cables. The first and second conductors of the primary twinaxial cable are electrically connected with the first and second conductors of the secondary twinaxial cable in the splice holder. The splice holder is dielectric to electrically isolate the first conductors of the primary and secondary twinaxial cables from the second conductors of the primary and secondary twinaxial cables. The splice connector includes an outer shell having a primary shroud forming a primary cavity receiving an end of the primary twinaxial cable, a secondary shroud forming a secondary cavity receiving an end of the secondary twinaxial cable, and a splice shroud forming a splice cavity receiving the splice holder. The outer shell is electrically conductive. The primary shroud is electrically connected to the primary cable shield. The secondary shroud is electrically connected to the secondary cable shield.

In a further embodiment, a cable assembly is provided and includes a primary twinaxial cable that includes a first conductor and a second conductor. The primary twinaxial cable includes a primary insulator holding the first and second conductors of the primary twinaxial cable. Exposed portions of the first and second conductors of the primary twinaxial cable protrude from the primary insulator. The primary twinaxial cable includes a primary cable shield surrounding the primary insulator to provide shielding for the first and second conductors of the primary twinaxial cable. The cable assembly includes a secondary twinaxial cable that includes a first conductor and a second conductor. The secondary twinaxial cable includes a secondary insulator holding the first and second conductors of the secondary twinaxial cable. Exposed portions of the first and second conductors of the secondary twinaxial cable protrude from the secondary insulator. The secondary twinaxial cable includes a secondary cable shield surrounding the secondary insulator to provide shielding for the first and second conductors of the secondary twinaxial cable. The cable assembly includes a splice connector between the primary twinaxial cable and the secondary twinaxial cable to electrically connect the first and second conductors of the primary twinaxial cable with the first and second conductors of the secondary twinaxial cable. The splice connector includes a contact assembly that includes a first contact and a second contact. The first contact is coupled to the exposed portions of the first conductors of the primary and secondary twinaxial cables. The second contact is coupled to the exposed portions of the second conductors of the primary and secondary twinaxial cables. The splice connector includes an outer shell having a primary shroud forming a primary cavity receiving an end of the primary twinaxial cable, a secondary shroud forming a secondary cavity receiving an end of the secondary twinaxial cable, and a splice shroud forming a splice cavity receiving the contact assembly. The outer shell is electrically conductive. The primary shroud is electrically connected to the primary cable shield. The secondary shroud is electrically connected to the secondary cable shield.

### BRIEF DESCRIPTION OF THE DRAWINGS

FIG. 1 illustrates a cable assembly in accordance with an exemplary embodiment.

FIG. 2 illustrates a portion of the cable assembly showing the primary twinaxial cable and the secondary twinaxial cable in accordance with an exemplary embodiment.

FIG. 3 is an exploded view of the cable assembly in accordance with an exemplary embodiment.

FIG. 4 is a cross sectional view of the cable assembly in accordance with an exemplary embodiment.

FIG. 5 illustrates the cable assembly in accordance with an exemplary embodiment.

FIG. 6 illustrates a portion of the cable assembly in accordance with an exemplary embodiment.

FIG. 7 illustrates the cable assembly in accordance with an exemplary embodiment.

FIG. 8 is a cross-sectional view of the cable assembly in accordance with an exemplary embodiment.

FIG. 9 is a cross-sectional view of the cable assembly in accordance with an exemplary embodiment.

### DETAILED DESCRIPTION OF THE INVENTION

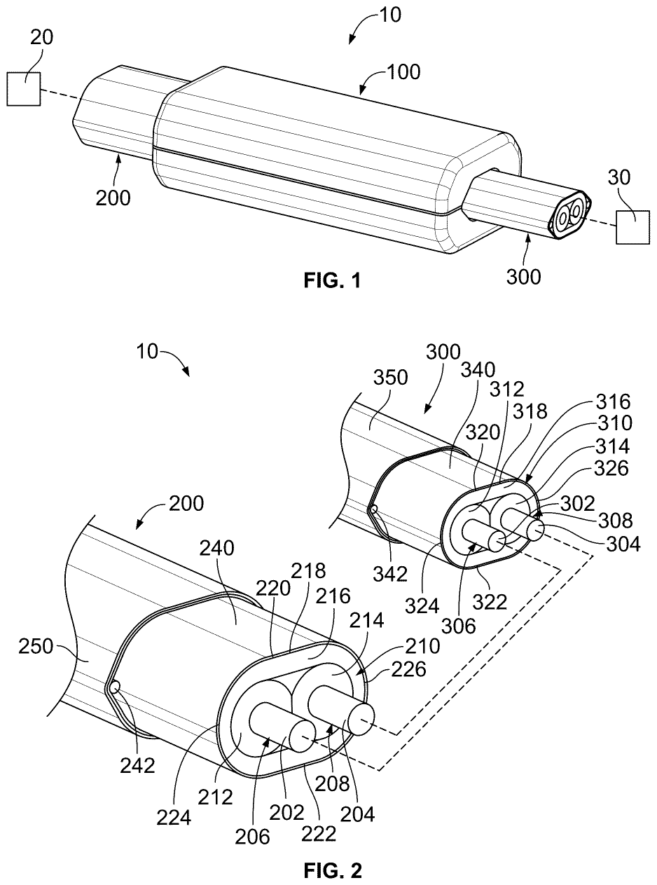

FIG. 1 illustrates a cable assembly 10 in accordance with an exemplary embodiment. The cable assembly 10 includes a splice connector 100 configured to electrically connect a primary twinaxial cable 200 and a secondary twinaxial cable 300. The primary twinaxial cable 200 is configured to be coupled to a first component 20 and the secondary twinaxial cable 300 is configured to be coupled to a second component 30. In an exemplary embodiment, the primary twinaxial cable 200 and the secondary twinaxial cable 300 are different sized twinaxial cables. The splice connector 100 is configured to electrically connect the different sized twinaxial cables 200, 300.

FIG. 2 illustrates a portion of the cable assembly 10 showing the primary twinaxial cable 200 and the secondary twinaxial cable 300 in accordance with an exemplary embodiment. In the illustrated embodiment, the primary twinaxial cable 200 and the secondary twinaxial cable 300 are different sized twinaxial cables with the primary twinaxial cable 200 larger than the secondary twinaxial cable 300 (for example, larger cross-sectional area and/or greater height and/or greater width and/or larger diameter conductors).

The primary twinaxial cable 200 includes a first conductor 202 and a second conductor 204. The primary twinaxial cable 200 includes a primary insulator 210 holding the first and second conductors 202, 204. Exposed portions 206, 208 of the first and second conductors 202, 204, respectively, protrude from the primary insulator 210, such as for connection to the secondary twinaxial cable 300. The primary twinaxial cable 200 includes a primary cable shield 240 surrounding the primary insulator 210 to provide shielding for the first and second conductors 202, 204. The primary twinaxial cable 200 includes a primary outer jacket 250 surrounding the primary cable shield 240.

The primary twinaxial cable 200 includes the first and second conductors 202, 204 arranged in parallel along the length of the primary twinaxial cable 200. The first and second conductors 202, 204 may be twisted along the length of the primary twinaxial cable 200. In an exemplary embodiment, the first and second conductors 202, 204 are used for differential, high speed signaling. Both of the first and second conductors 202, 204 are arranged within the shield space defined by the primary cable shield 240. The primary insulator 210 insulates the first and second conductors 202, 204 from each other and from the primary cable shield 240. The first and second conductors 202, 204 are metal conductors, such as copper conductors. In various embodiments, the first and second conductors 202, 204 may be solid core conductors. In other embodiments, the first and second conductors 202, 204 may be stranded wires. In an exemplary embodiment, the first and second conductors 202, 204 are cylindrical conductors having a diameter larger than the diameter of the conductors of the secondary twinaxial cable 300. The diameters of the first and second conductors 202, 204 may be selected to have a particular impedance. The twinaxial nature of the first and second conductors 202, 204 offer low latency and high bandwidth for data communication, such as for use in data centers, enterprise networks, LAN networks, server interconnections, or other applications requiring high-frequency data transfer. The larger diameter conductors may maintain signal integrity over longer lengths or distances compared to the smaller diameter conductors of the secondary twinaxial cable 300.

The primary insulator 210 surrounds the first and second conductors 202, 204. The primary insulator 210 is made from a dielectric material, such as a polyethylene or a polypropylene material. The primary insulator 210 may be extruded with the first and second conductors 202, 204. In various embodiments, the primary insulator 210 may be a multi-piece insulator including a first insulator element 212 surrounding the first conductor 202 and a second insulator element 214 surrounding the second conductor 204. The first and second insulator elements 212, 214 are separate and discrete such as being separately extruded. The first and second insulator elements 212, 214 may be surrounded by an outer insulator 216. In alternative embodiments, the primary insulator 210 may be a single insulator element surrounding both of the first and second conductors 202, 204.

The primary insulator 210 includes an outer perimeter 218. The primary cable shield 240 surrounds the outer perimeter 218. For example, the primary cable shield 240 may be wrapped around the outer perimeter 218. The primary insulator 210 has first and second sides 220, 222 and first and second ends 224, 226 between the first and second sides 220, 222. In the illustrated embodiment, the sides 220, 222 are planar and parallel to each other. The ends 224, 226 are curved between the sides 220, 222. In various embodiments, the primary insulator 210 is generally oval shaped, such as racetrack shaped. However, the primary insulator 210 may have other shapes in alternative embodiments.

A thickness of the primary insulator 210 is selected to control the spacing between the primary cable shield 240 and the first and second conductors 202, 204. The spacing controls electrical characteristics, such as the impedance. In an exemplary embodiment, the spacing between the primary cable shield 240 and the first and second conductors 202, 204 is generally uniform, such as having the same or similar spacing from the sides 220, 222 and from the ends 224, 226.

The primary cable shield 240 is formed, at least in part, of a conductive material. In an exemplary embodiment, the primary cable shield 240 is a tape configured to be wrapped around the cable core. For example, the primary cable shield 240 may include a multi-layer tape having a conductive layer and an insulating layer, such as a backing layer. The conductive layer and the backing layer may be secured together by adhesive. Optionally, the primary cable shield 240 may include an adhesive layer, such as along the interior side to secure the primary cable shield 240 to the outer perimeter 218 of the primary insulator 210 and/or itself. The conductive layer may be a conductive foil or another type of conductive layer. The insulating layer may be a polyethylene terephthalate (PET) film, or similar type of film. The conductive layer provides electrical shielding for the first and second conductors 202, 204 from external sources of EMI/RFI interference and/or to block cross-talk between other conductors, connectors, or cables. In an exemplary embodiment, the primary cable shield 240 includes a wrap or another layer around the inner cable shield that holds the inner cable shield on the insulator 210. For example, the primary cable shield 240 may include a helical wrap, such as a heat shrink wrap.

In an exemplary embodiment, the primary twinaxial cable 200 includes one or more primary drain wires 242 extending the cable length. The primary drain wires 242 are electrically connected to the primary cable shield 240. The primary drain wires 242 may be terminated to other components at the ends of the primary twinaxial cable 200.

The primary outer jacket 250 surrounds and may engage the outer perimeter of the primary cable shield 240 and/or the primary drain wire(s) 242. The primary outer jacket 250 is formed of at least one dielectric material, such as one or more plastics (for example, vinyl, polyvinyl chloride (PVC), acrylonitrile butadiene styrene (ABS), or the like). The primary outer jacket 250 is non-conductive, and is used to insulate the primary cable shield 240 from objects outside of the primary twinaxial cable 200. The primary outer jacket 250 also protects the primary cable shield 240 and the other internal components from mechanical forces, contaminants, and elements (such as fluctuating temperature and humidity). Optionally, the primary outer jacket 250 may be extruded or otherwise molded around the primary cable shield 240. Alternatively, the primary outer jacket 250 may be wrapped around the primary cable shield 240 or heat shrunk around the primary cable shield 240.

The secondary twinaxial cable 300 includes a first conductor 302 and a second conductor 304. The secondary twinaxial cable 300 includes a secondary insulator 310 holding the first and second conductors 302, 304. Exposed portions 306, 308 of the first and second conductors 302, 304, respectively, protrude from the secondary insulator 310, such as for connection to the primary twinaxial cable 200. The secondary twinaxial cable 300 includes a secondary cable shield 340 surrounding the secondary insulator 310 to provide shielding for the first and second conductors 302, 304. The secondary twinaxial cable 300 includes a secondary outer jacket 350 surrounding the secondary cable shield 340.

The secondary twinaxial cable 300 includes the first and second conductors 302, 304 arranged in parallel along the length of the secondary twinaxial cable 300. The first and second conductors 302, 304 may be twisted along the length of the secondary twinaxial cable 300. In an exemplary embodiment, the first and second conductors 302, 304 are used for differential, high speed signaling. Both of the first and second conductors 302, 304 are arranged within the shield space defined by the secondary cable shield 340. The secondary insulator 310 insulates the first and second conductors 302, 304 from each other and from the secondary cable shield 340. The first and second conductors 302, 304 are metal conductors, such as copper conductors. In various embodiments, the first and second conductors 302, 304 may be solid core conductors. In other embodiments, the first and second conductors 302, 304 may be stranded wires. In an exemplary embodiment, the first and second conductors 302, 304 are cylindrical conductors having a diameter smaller than the diameter of the conductors 202, 204 of the primary twinaxial cable 200. The diameters of the first and second conductors 302, 304 may be selected to have a particular impedance. The twinaxial nature of the first and second conductors 302, 304 offer low latency and high bandwidth for data communication, such as for use in data centers, enterprise networks, LAN networks, server interconnections, or other applications requiring high-frequency data transfer. The smaller diameter conductors, as well as the smaller overall cross-sectional area of the secondary twinaxial cable 300, makes the secondary twinaxial cable 300 more flexible (compared to the larger size primary twinaxial cable 200) for routing within the communication system. The smaller size of the secondary twinaxial cables 300 allows for higher cable density in a smaller space, such as for connection to a small size electrical component, such as for termination to a circuit card or circuit board or for termination to a high density contact array of an electrical connector.

The secondary insulator 310 surrounds the first and second conductors 302, 304. The secondary insulator 310 is made from a dielectric material, such as a polyethylene or a polypropylene material. The secondary insulator 310 may be extruded with the first and second conductors 302, 304. In various embodiments, the secondary insulator 310 may be a multi-piece insulator including a first insulator element 312 surrounding the first conductor 302 and a second insulator element 314 surrounding the second conductor 304. The first and second insulator elements 312, 314 are separate and discrete such as being separately extruded. The first and second insulator elements 312, 314 may be surrounded by an outer insulator 316. In alternative embodiments, the secondary insulator 310 may be a single insulator element surrounding both of the first and second conductors 302, 304.

The secondary insulator 310 includes an outer perimeter 318. The secondary cable shield 340 surrounds the outer perimeter 318. For example, the secondary cable shield 340 may be wrapped around the outer perimeter 318. The secondary insulator 310 has first and second sides 320, 322 and first and second ends 324, 326 between the first and second sides 320, 322. In the illustrated embodiment, the sides 320, 322 are planar and parallel to each other. The ends 324, 326 are curved between the sides 320, 322. In various embodiments, the secondary insulator 310 is generally oval shaped, such as racetrack shaped. However, the secondary insulator 310 may have other shapes in alternative embodiments.

A thickness of the secondary insulator 310 is selected to control the spacing between the secondary cable shield 340 and the first and second conductors 302, 304. The spacing controls electrical characteristics, such as the impedance. In an exemplary embodiment, the spacing between the secondary cable shield 340 and the first and second conductors 302, 304 is generally uniform, such as having the same or similar spacing from the sides 320, 322 and from the ends 324, 326.

The secondary cable shield 340 is formed, at least in part, of a conductive material. In an exemplary embodiment, the secondary cable shield 340 is a tape configured to be wrapped around the cable core. For example, the secondary cable shield 340 may include a multi-layer tape having a conductive layer and an insulating layer, such as a backing layer. The conductive layer and the backing layer may be secured together by adhesive. Optionally, the secondary cable shield 340 may include an adhesive layer, such as along the interior side to secure the secondary cable shield 340 to the outer perimeter 318 of the secondary insulator 310 and/or itself. The conductive layer may be a conductive foil or another type of conductive layer. The insulating layer may be a polyethylene terephthalate (PET) film, or similar type of film. The conductive layer provides electrical shielding for the first and second conductors 302, 304 from external sources of EMI/RFI interference and/or to block cross-talk between other conductors, connectors, or cables. In an exemplary embodiment, the secondary cable shield 340 includes a wrap or another layer around the inner cable shield that holds the inner cable shield on the insulator 310. For example, the secondary cable shield 340 may include a helical wrap, such as a heat shrink wrap.

In an exemplary embodiment, the secondary twinaxial cable 300 includes one or more secondary drain wires 342 extending the cable length. The secondary drain wires 342 are electrically connected to the secondary cable shield 340. The secondary drain wires 342 may be terminated to other components at the ends of the secondary twinaxial cable 300.

The secondary outer jacket 350 surrounds and may engage the outer perimeter of the secondary cable shield 340 and/or the secondary drain wire(s) 342. The secondary outer jacket 350 is formed of at least one dielectric material, such as one or more plastics (for example, vinyl, polyvinyl chloride (PVC), acrylonitrile butadiene styrene (ABS), or the like). The secondary outer jacket 350 is non-conductive, and is used to insulate the secondary cable shield 340 from objects outside of the secondary twinaxial cable 300. The secondary outer jacket 350 also protects the secondary cable shield 340 and the other internal components from mechanical forces, contaminants, and elements (such as fluctuating temperature and humidity). Optionally, the secondary outer jacket 350 may be extruded or otherwise molded around the secondary cable shield 340. Alternatively, the secondary outer jacket 350 may be wrapped around the secondary cable shield 340 or heat shrunk around the secondary cable shield 340.

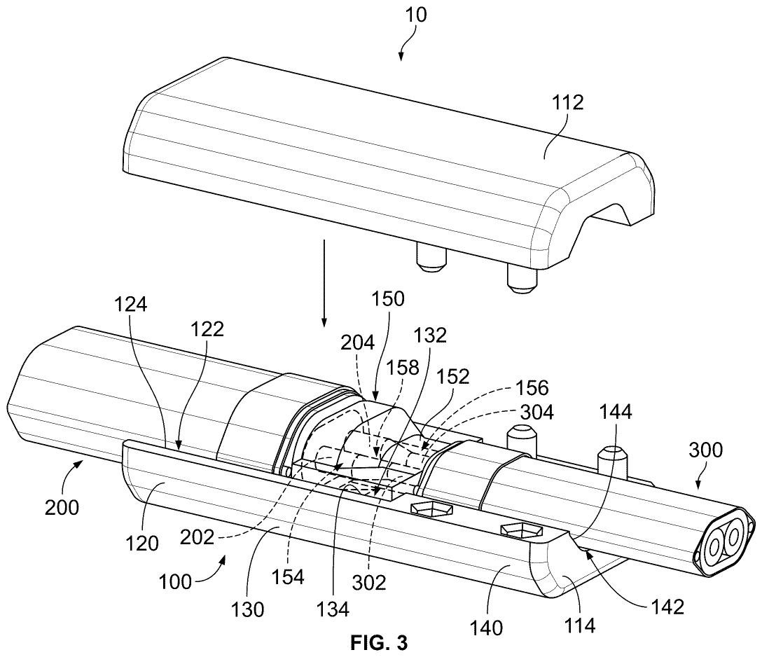

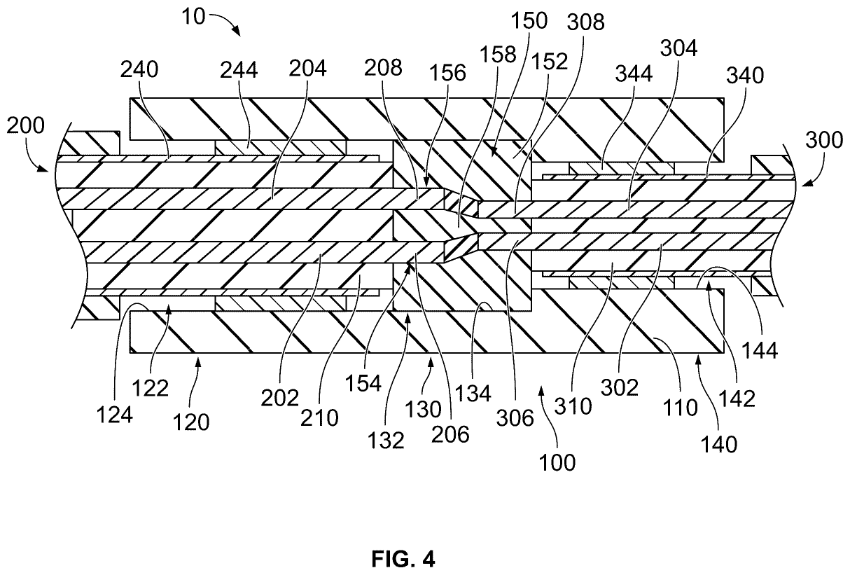

FIG. 3 is an exploded view of the cable assembly 10 in accordance with an exemplary embodiment. FIG. 4 is a cross sectional view of the cable assembly 10 in accordance with an exemplary embodiment. The splice connector 100 is positioned between the primary and secondary twinaxial cables 200, 300 to electrically connect the primary and secondary twinaxial cables 200, 300. For example, the splice connector 100 is used to electrically connect the first and second conductors 202, 204 of the primary twinaxial cable 200 with the first and second conductors 302, 304 of the secondary twinaxial cable 300. The splice connector 100 is used to electrically connect the primary cable shield 240 and the secondary cable shield 340.

The splice connector 100 includes an outer shell 110 configured to hold the other components of the cable assembly 10. In an exemplary embodiment, the splice connector 100 includes a splice holder 150 configured to hold the ends of the primary and secondary twinaxial cables 200, 300, such as to hold the exposed portions 206, 208, 306, 308 of the conductors 202, 204, 302, 304.

In an exemplary embodiment, the outer shell 110 is a multi-piece component, such as including an upper shell member 112 and a lower shell member 114 coupled to the upper shell member 112 to capture the primary twinaxial cable 200 and the secondary twinaxial cable 300 therebetween. The upper and lower shell members 112, 114 are coupled together, such as using pins and openings, adhesive, clips, fasteners, and the like. The upper and lower shell members 112, 114 may be hermaphroditic, such as including both pins and openings. The upper and lower shell members 112, 114 may be identical and inverted 180°. In an exemplary embodiment, the outer shell 110 may be diecast, machined, plated plastic, stamped and formed, or manufactured by other processes. In alternative embodiments, the outer shell 110 may be a single-piece shell member.

In an exemplary embodiment, the outer shell 110 is conductive and is configured to provide shielding for the splice connection and is configured to electrically connect the primary and secondary cable shields 240, 340. The outer shell 110 may mechanically hold the ends of the primary and secondary twinaxial cables 200, 300 relative to each other, such as for alignment and/or to provide strain relief on the splice connection. The outer shell 110 includes a primary shroud 120, a secondary shroud 140, and a splice shroud 130 between the primary shroud 120 and the secondary shroud 140. In an exemplary embodiment, the primary shroud 120, the splice shroud 130, and the secondary shroud 140 are integrated into a common shroud structure.

The primary shroud 120 forms a primary cavity 122 that receives an end of the primary twinaxial cable 200. The primary shroud 120 has an inner surface 124 forming the primary cavity 122. The primary cavity 122 is sized and shaped to receive the primary twinaxial cable 200. For example, the primary cavity 122 may have a cross-sectional area that matches the cross-sectional area of the primary twinaxial cable 200. For example, the primary cavity 122 may be oval shaped. The primary cavity 122 may have a larger cross-sectional area than the splice cavity of the splice shroud and/or the secondary cavity of the secondary shroud 140 due to the larger size of the primary twinaxial cable 200.

The primary shroud 120 is configured to be electrically connected to the primary cable shield 240. For example, the inner surface 124 of the primary shroud 120 may directly engage the primary cable shield 240. Alternatively, the primary shroud 120 may interface with a primary conductive interface element 244 located between the primary cable shield 240 and the inner surface 124 of the primary shroud 120. The primary conductive interface element 244 is a conductive material forming an interface between the primary cable shield 240 and the primary shroud 120. The primary conductive interface element 244 may be located at or near the end of the primary cable shield 240. In various embodiments, the primary conductive interface element 244 is applied to the primary cable shield 240. In other embodiments, the primary conductive interface element 244 is applied to the inner surface 124 of the primary shroud 120. The primary conductive interface element 244 may be compressible between the primary cable shield 240 and the primary shroud 120. The primary conductive interface element 244 may be conductive epoxy, solder, conductive adhesive, a conductive tape or foil, or other conductive material.

In an exemplary embodiment, the primary shroud 120 of the outer shell 110 has multiple points of contact with the primary cable shield 240 and/or the primary conductive interface element 244. For example, the primary shroud 120 may have points of contact at least with the top, the bottom, and both sides. In an exemplary embodiment, the inner surface 124 of the primary shroud 120 matches a shape of the primary cable shield 240, or the primary conductive interface element 244, to provide 360° connection to the primary cable shield 240 and/or the primary conductive interface element 244.

The secondary shroud 140 forms a secondary cavity 142 that receives an end of the secondary twinaxial cable 300. The secondary shroud 140 has an inner surface 144 forming the secondary cavity 142. The secondary cavity 142 is sized and shaped to receive the secondary twinaxial cable 300. For example, the secondary cavity 142 may have a cross-sectional area that matches the cross-sectional area of the secondary twinaxial cable 300. For example, the secondary cavity 142 may be oval shaped. The secondary cavity 142 may have a smaller cross-sectional area than the splice cavity of the splice shroud and/or the primary cavity 122 of the primary shroud 120 due to the smaller size of the secondary twinaxial cable 300.

The secondary shroud 140 is configured to be electrically connected to the secondary cable shield 340. For example, the inner surface 144 of the secondary shroud 140 may directly engage the secondary cable shield 340. Alternatively, the secondary shroud 140 may interface with a secondary conductive interface element 344 located between the secondary cable shield 340 and the inner surface 144 of the secondary shroud 140. The secondary conductive interface element 344 is a conductive material forming an interface between the secondary cable shield 340 and the secondary shroud 140. The secondary conductive interface element 344 may be located at or near the end of the secondary cable shield 340. In various embodiments, the secondary conductive interface element 344 is applied to the secondary cable shield 340. In other embodiments, the secondary conductive interface element 344 is applied to the inner surface 144 of the secondary shroud 140. The secondary conductive interface element 344 may be compressible between the secondary cable shield 340 and the secondary shroud 140. The secondary conductive interface element 344 may be conductive epoxy, solder, conductive adhesive, a conductive tape or foil, or other conductive material.

In an exemplary embodiment, the secondary shroud 140 of the outer shell 110 has multiple points of contact with the secondary cable shield 340 and/or the secondary conductive interface element 344. For example, the secondary shroud 140 may have points of contact at least with the top, the bottom, and both sides. In an exemplary embodiment, the inner surface 144 of the secondary shroud 140 matches a shape of the secondary cable shield 340, or the secondary conductive interface element 344, to provide 360° connection to the secondary cable shield 340 and/or the secondary conductive interface element 344.

The splice shroud 130 forms a splice cavity 132 between the primary and secondary cavities 122, 142. For example, the splice shroud 130 has an inner surface 134 forming the splice cavity 132. The splice cavity 132 may transition between the larger primary cavity 122 and the smaller secondary cavity 142. For example, the inner surface 134 may be angled and/or stepped between the inner surfaces 124, 144. The splice cavity 132 receives the exposed portions 206, 208, 306, 308 of the conductors 202, 204, 302, 304 of the primary and secondary twinaxial cables 200, 300. The first and second conductors 202, 204 of the primary twinaxial cable 200 are electrically connected with the first and second conductors 302, 304 of the secondary twinaxial cable 300 in the splice cavity 132. In an exemplary embodiment, the splice cavity 132 is sized and shaped to receive the splice holder 150, which holds the conductors 202, 204, 302, 304. The inner surface 134 may include walls, surfaces or other features for locating the splice holder 150 in the splice cavity 132.

The splice holder 150 includes a dielectric body 152. The dielectric body 152 may be a plastic material. The dielectric body 152 may be a hot melt material. The dielectric body 152 may be an epoxy material. The splice holder 150 is configured to hold the exposed portions 206, 208, 306, 308 of the conductors 202, 204, 302, 304 of the primary and secondary twinaxial cables 200, 300. The splice holder 150 may hold the ends of the primary and secondary twinaxial cables 200, 300, such as the insulators 210, 310 and/or the cable shields 240, 340. For example, the splice holder 150 may include a tray or pocket that receives the end of the primary twinaxial cable 200 and/or the secondary twinaxial cable 300. The splice holder 150 may include multiple pieces, such as a first holder member holding the first conductors 202, 302 and a second holder member holding the second conductors 204, 304. The splice holder 150 electrically isolates the first conductors 202, 302 from the second conductors 204, 304. In an exemplary embodiment, the splice holder 150 includes a first channel 154 receiving the first conductors 202, 302 and a second channel 156 receiving the second conductors 204, 304. The splice holder 150 includes a separating wall 158 between the first and second channels 154, 156. In an exemplary embodiment, the splice holder 150 may be pre-formed. For example, the splice holder 150 may be a molded part. In other various embodiments, the splice holder 150 may be formed in place in the outer shell 110. For example, the splice holder 150 may be injection molded in place in the outer shell 110.

In an exemplary embodiment, the first conductors 202, 302 are electrically connected to create a first transmission line and the second conductors 204, 304 are electrically connected to create a second transmission line. The first conductors 202, 302 are electrically connected together in the first channel 154 and the second conductors 204, 304 are electrically connected together in the second channel 156. In various embodiments, the first conductors 202, 302 may be welded or soldered together and the second conductors 204, 304 may be welded or soldered together. For example, the first conductor 202 may be butt welded or lap welded to the first conductor 302 and the second conductor 204 may be butt welded or lap welded to the second conductor 304.

In various embodiments, the first conductors 202, 302 may be electrically connected together prior to reception in the first channel 154 and the second conductors 204, 304 may be electrically connected together prior to reception in the second channel 156. In other various embodiments, the splice holder 150 may be overmolded over the connection between the conductors 202, 204, 302, 304. Alternatively, the first conductors 202, 302 may be electrically connected together in place in the first channel 154 and the second conductors 204, 304 may be electrically connected together in place in the second channel 156. In other embodiments, the splice holder 150 may hold contacts (not shown) used to electrically connect the first conductors 202, 302 together and electrically connect the second conductors 204, 304 together.

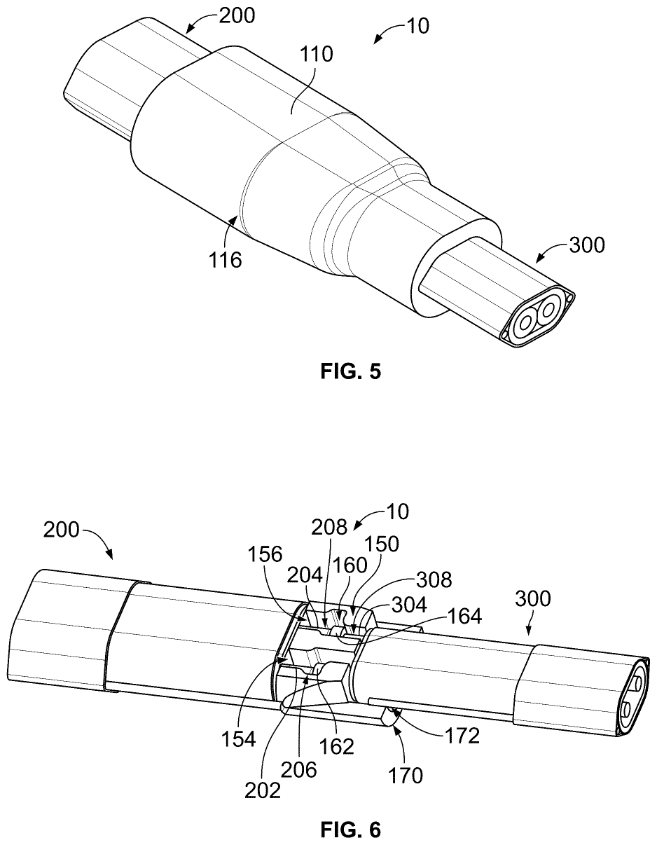

FIG. 5 illustrates the cable assembly 10 in accordance with an exemplary embodiment. In the illustrated embodiment, the outer shell 110 includes a conductive heat shrink sleeve 116 applied over the ends of the primary and secondary twinaxial cables 200, 300 and over the splice holder 150. The heat shrink sleeve 116 conforms to the ends of the primary and secondary twinaxial cables 200, 300 and over the splice holder 150. The heat shrink sleeve 116 is conductive to allow electrical connection to the primary cable shield 240 and/or the primary conductive interface element 244 and electrical connection to the secondary cable shield 340 and/or the secondary conductive interface element 344.

FIG. 6 illustrates a portion of the cable assembly 10 in accordance with an exemplary embodiment. In the illustrated embodiment, the splice holder 150 is a pre-formed (for example, molded) part having the first and second channels 154, 156 open at the top to receive the exposed portions 206, 208, 306, 308 of the conductors 202, 204, 302, 304 of the primary and secondary twinaxial cables 200, 300.

In an exemplary embodiment, the cable assembly 10 includes a contact assembly 160 having first and second contacts 162, 164 hold by the splice holder 150. The first contact 162 electrically connects the first conductors 202, 302 together. The second contact 164 electrically connects the second conductors 204, 304 together. The first and second contacts 162, 164 are received in the first and second channels 154, 156. The splice holder 150 may include walls, surfaces or other features for locating the first and second contacts 162, 164 in the splice holder 150.

In an exemplary embodiment, the splice holder 150 includes a tray 170 at an end having a pocket 172 that receives an end of the second twinaxial cable 300. The tray 170 supports the second twinaxial cable 300 and positions the second twinaxial cable 300 to axially align the first and second conductors 302, 304 of the secondary twinaxial cable 300 with the first and second conductors 202, 204 of the primary twinaxial cable 200. For example, due to the size differences between the primary and secondary twinaxial cables 200, 300, the secondary twinaxial cable 300 needs to be elevated to align the centerline of the secondary twinaxial cable 300 with the centerline of the primary twinaxial cable 200. The splice holder 150 may include another tray at the opposite end to support the primary twinaxial cable 200.

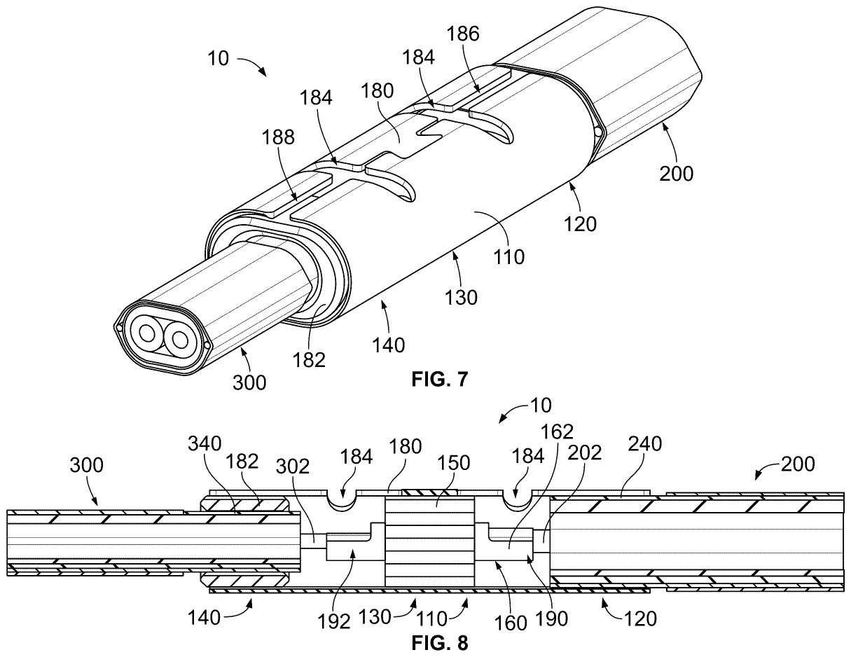

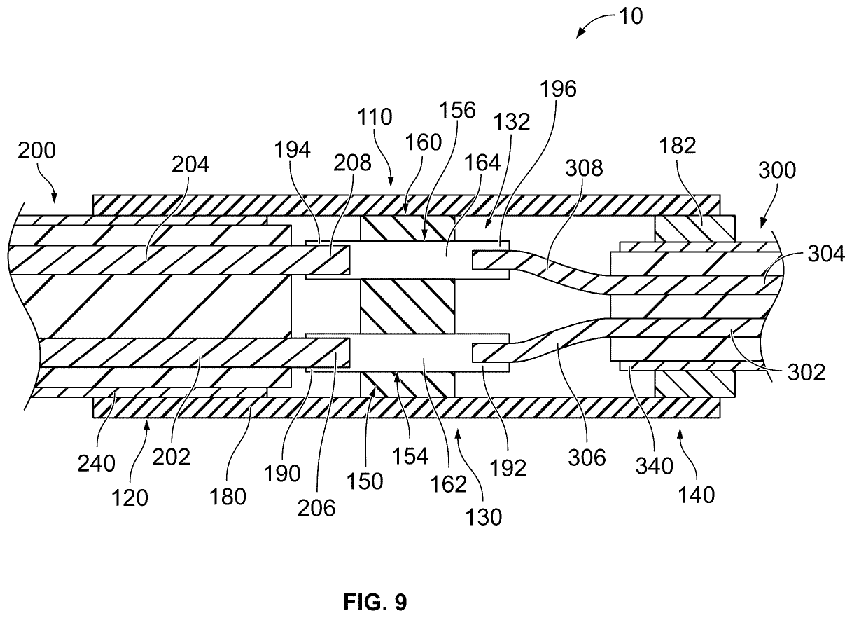

FIG. 7 illustrates the cable assembly 10 in accordance with an exemplary embodiment. FIG. 8 is a cross-sectional view of the cable assembly 10 in accordance with an exemplary embodiment. FIG. 9 is a cross-sectional view of the cable assembly 10 in accordance with an exemplary embodiment.

In the illustrated embodiment, the outer shell 110 includes a stamped and formed body 180 that forms the primary shroud 120, the secondary shroud 140, and the splice shroud 130 between the primary shroud 120 and the secondary shroud 140. In the illustrated embodiment, the stamped and formed body 180 has a uniform shape between the ends (for example, uniform cavity size) sized to accommodate the larger sized primary twinaxial cable 200. In an exemplary embodiment, the cable assembly 10 includes a conductive adapter 182 filling the gap or space between the smaller secondary twinaxial cable and the stamped and formed body 180.

In an exemplary embodiment, the cable assembly 10 includes the contact assembly 160. The contact assembly 160 includes the splice holder 150 and the first and second contacts 162, 164. In various embodiments, the splice holder 150 may be overmolded over the first and second contacts 162, 164. Alternatively, the first and second contacts 162, 164 may be loaded into the splice holder 150, such as from one of the ends. In various embodiments, the first and second contacts 162, 164 may be stamped and formed contacts or machined contacts. The first and second contacts 162, 164 are received in the first and second channels 154, 156. The first contact 162 is coupled to the exposed portions 206, 306 of the first conductors 202, 302 of the primary and secondary twinaxial cables 200, 300. For example, the first contact 162 includes sockets 190, 192 at the ends that receive the exposed portions 206, 306, respectively. The exposed portions 206, 306 may be soldered or welded to the first contact 162 in the sockets 190, 192. Alternatively, the sockets 190, 192 may be crimped to the exposed portions 206, 306. The second contact 164 is coupled to the exposed portions 208, 308 of the second conductors 204, 304 of the primary and secondary twinaxial cables 200, 300. For example, the second contact 164 includes sockets 194, 196 at the ends that receive the exposed portions 208, 308, respectively. The exposed portions 208, 308 may be soldered or welded to the second contact 164 in the sockets 194, 196. Alternatively, the sockets 194, 196 may be crimped to the exposed portions 208, 308.

In an exemplary embodiment, the stamped and formed body 180 of the outer shell 110 includes splice windows 184 aligned with the splice cavity 132 to access the first and second contacts 162, 164 for joining the first and second conductors 202, 204, 302, 304 of the primary and secondary twinaxial cables 200, 300 with the first and second contacts 162, 164. For example, the first and second conductors 202, 204, 302, 304 of the primary and secondary twinaxial cables 200, 300 may be laser welded or soldered to the first and second contacts 162, 164 through the splice windows 184.

In an exemplary embodiment, the stamped and formed body 180 of the outer shell 110 includes a primary window 186 at the primary shroud 120 exposing the primary twinaxial cable 200 for connecting the primary shroud 120 to the primary twinaxial cable 200. For example, the stamped and formed body 180 may be soldered or welded to the primary cable shield 240 through the primary window 186. The stamped and formed body 180 may include multiple primary windows 186 for connection at different locations around the outer shell 110.

In an exemplary embodiment, the stamped and formed body 180 of the outer shell 110 includes a secondary window 188 at the secondary shroud 140 exposing the secondary twinaxial cable 300 for connecting the secondary shroud 140 to the secondary twinaxial cable 300. For example, the stamped and formed body 180 may be soldered or welded to the secondary cable shield 340 through the secondary window 188. The stamped and formed body 180 may be soldered or welded to the conductive adapter 182 through the secondary window 188. The stamped and formed body 180 may include multiple secondary windows 188 for connection at different locations around the outer shell 110.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means - plus-function format and are not intended to be interpreted based on 35 U.S.C. § 112(f), unless and until such claim limitations expressly use the phrase “means for” followed by a statement of function void of further structure.

What is claimed is:

1. A cable assembly comprising:
a primary twinaxial cable including a first conductor and a second conductor, the primary twinaxial cable including a primary insulator holding the first and second conductors of the primary twinaxial cable, exposed portions of the first and second conductors of the primary twinaxial cable protruding from the primary insulator, the primary twinaxial cable including a primary cable shield surrounding the primary insulator to provide shielding for the first and second conductors of the primary twinaxial cable;
a secondary twinaxial cable including a first conductor and a second conductor, the secondary twinaxial cable including a secondary insulator holding the first and second conductors of the secondary twinaxial cable, exposed portions of the first and second conductors of the secondary twinaxial cable protruding from the secondary insulator, the secondary twinaxial cable including a secondary cable shield surrounding the secondary insulator to provide shielding for the first and second conductors of the secondary twinaxial cable;
a splice connector between the primary twinaxial cable and the secondary twinaxial cable to electrically connect the first and second conductors of the primary twinaxial cable with the first and second conductors of the secondary twinaxial cable, the splice connector including an outer shell having a primary shroud forming a primary cavity receiving an end of the primary twinaxial cable, a secondary shroud forming a secondary cavity receiving an end of the secondary twinaxial cable, and a splice shroud forming a splice cavity receiving the exposed portions of the first and second conductors of the primary and secondary twinaxial cables, wherein the first and second conductors of the primary twinaxial cable are electrically connected with the first and second conductors of the secondary twinaxial cable in the splice cavity, the outer shell being electrically conductive, the primary shroud being electrically connected to the primary cable shield, the secondary shroud being electrically connected to the secondary cable shield.

2. The cable assembly of claim 1, wherein the outer shell has multiple points of contact with the primary cable shield and multiple points of contact with the secondary cable shield.

3. The cable assembly of claim 1, wherein the outer shell has an inner surface at the primary shroud matching a shape of the primary cable shield to provide 360° connection to the primary cable shield and the outer shell has an inner surface at the secondary shroud matching a shape of the secondary cable shield to provide 360° connection to the secondary cable shield.

4. The cable assembly of claim 1, wherein the primary twinaxial cable has a first cross-sectional area and the secondary twinaxial cable has a second cross-sectional area smaller than the first cross-sectional area.

5. The cable assembly of claim 1, wherein the primary cavity has a first cross-sectional area and the secondary cavity has a second cross-sectional area smaller than the first cross-sectional area.

6. The cable assembly of claim 1, wherein the primary twinaxial cable includes a primary conductive interface element between the primary cable shield and an inner surface of the primary shroud, the secondary twinaxial cable including a secondary conductive interface element between the secondary cable shield and an inner surface of the secondary shroud.

7. The cable assembly of claim 1, wherein the outer shell includes an upper shell member and a lower shell member coupled to the upper shell member to capture the primary twinaxial cable and the secondary twinaxial cable therebetween.

8. The cable assembly of claim 1, wherein the outer shell is a conductive heat shrink element conforming to the primary twinaxial cable and the secondary twinaxial cable to mechanically and electrically connect to the primary twinaxial cable and the secondary twinaxial cable.

9. The cable assembly of claim 1, wherein the outer shell includes a primary window at the primary shroud exposing the primary twinaxial cable for connecting the primary shroud to the primary twinaxial cable, the outer shell including a secondary window at the secondary shroud exposing the secondary twinaxial cable for connecting the secondary shroud to the secondary twinaxial cable.

10. The cable assembly of claim 1, wherein the splice connector includes a splice holder receiving and holding the exposed portions of the first and second conductors of the primary and secondary twinaxial cables, the first and second conductors of the primary twinaxial cable being electrically connected with the first and second conductors of the secondary twinaxial cable in the splice holder, the splice holder being dielectric to electrically isolate the first conductors of the primary and secondary twinaxial cables from the second conductors of the primary and secondary twinaxial cables.

11. The cable assembly of claim 10, wherein the splice holder includes a first channel receiving the first conductors and a second channel receiving the second conductors, the first conductors being electrically connected in the first channel, the second conductors being electrically connected in the second channel, the splice holder including a separating wall between the first and second channels.

12. The cable assembly of claim 10, wherein the splice holder includes a tray having a pocket receiving an end of the second twinaxial cable, the tray positioned to axially align the first and second conductors of the secondary twinaxial cable with the first and second conductors of the primary twinaxial cable.

13. The cable assembly of claim 10, wherein the splice holder holds a first contact and a second contact, the first contact being coupled to the exposed portions of the first conductors of the primary and secondary twinaxial cables, the second contact being coupled to the exposed portions of the second conductors of the primary and secondary twinaxial cables.

14. The cable assembly of claim 1, wherein the splice connector includes a contact assembly having a first contact and a second contact, the first contact being coupled to the exposed portions of the first conductors of the primary and secondary twinaxial cables, the second contact being coupled to the exposed portions of the second conductors of the primary and secondary twinaxial cables.

15. The cable assembly of claim 14, wherein the contact assembly includes a splice holder holding the first contact and the second contact.

16. The cable assembly of claim 14, wherein the outer shield includes splice windows aligned with the splice cavity to access the first and second contacts for joining the first and second conductors of the primary and secondary twinaxial cables with the first and second contacts.

17. The cable assembly of claim 1, wherein the first conductors of the primary and secondary twinaxial cables are one of welded or soldered together to create a first transmission line and the second conductors of the primary and secondary twinaxial cables are one of welded or soldered together to create a second transmission line.

18. A cable assembly comprising:
a primary twinaxial cable including a first conductor and a second conductor, the primary twinaxial cable including a primary insulator holding the first and second conductors of the primary twinaxial cable, exposed portions of the first and second conductors of the primary twinaxial cable protruding from the primary insulator, the primary twinaxial cable including a primary cable shield surrounding the primary insulator to provide shielding for the first and second conductors of the primary twinaxial cable;
a secondary twinaxial cable including a first conductor and a second conductor, the secondary twinaxial cable including a secondary insulator holding the first and second conductors of the secondary twinaxial cable, exposed portions of the first and second conductors of the secondary twinaxial cable protruding from the secondary insulator, the secondary twinaxial cable including a secondary cable shield surrounding the secondary insulator to provide shielding for the first and second conductors of the secondary twinaxial cable;
a splice connector between the primary twinaxial cable and the secondary twinaxial cable to electrically connect the first and second conductors of the primary twinaxial cable with the first and second conductors of the secondary twinaxial cable, the splice connector including a splice holder receiving and holding the exposed portions of the first and second conductors of the primary and secondary twinaxial cables, the first and second conductors of the primary twinaxial cable are electrically connected with the first and second conductors of the secondary twinaxial cable in the splice holder, the splice holder being dielectric to electrically isolate the first conductors of the primary and secondary twinaxial cables from the second conductors of the primary and secondary twinaxial cables, the splice connector including an outer shell having a primary shroud forming a primary cavity receiving an end of the primary twinaxial cable, a secondary shroud forming a secondary cavity receiving an end of the secondary twinaxial cable, and a splice shroud forming a splice cavity receiving the splice holder, the outer shell being electrically conductive, the primary shroud being electrically connected to the primary cable shield, the secondary shroud being electrically connected to the secondary cable shield.

19. The cable assembly of claim 18, wherein the splice holder includes a first channel receiving the first conductors and a second channel receiving the second conductors, the first conductors being electrically connected in the first channel, the second conductors being electrically connected in the second channel, the splice holder including a separating wall between the first and second channels.

20. The cable assembly of claim 18, wherein the splice holder includes a tray having a pocket receiving an end of the second twinaxial cable, the tray positioned to axially align the first and second conductors of the secondary twinaxial cable with the first and second conductors of the primary twinaxial cable.

21. The cable assembly of claim 18, wherein the splice holder holds a first contact and a second contact, the first contact being coupled to the exposed portions of the first conductors of the primary and secondary twinaxial cables, the second contact being coupled to the exposed portions of the second conductors of the primary and secondary twinaxial cables.

22. The cable assembly of claim 18, wherein the outer shell has an inner surface at the primary shroud matching a shape of the primary cable shield to provide 360° connection to the primary cable shield and the outer shell has an inner surface at the secondary shroud matching a shape of the secondary cable shield to provide 360° connection to the secondary cable shield.

23. A cable assembly comprising:
a primary twinaxial cable including a first conductor and a second conductor, the primary twinaxial cable including a primary insulator holding the first and second conductors of the primary twinaxial cable, exposed portions of the first and second conductors of the primary twinaxial cable protruding from the primary insulator, the primary twinaxial cable including a primary cable shield surrounding the primary insulator to provide shielding for the first and second conductors of the primary twinaxial cable;
a secondary twinaxial cable including a first conductor and a second conductor, the secondary twinaxial cable including a secondary insulator holding the first and second conductors of the secondary twinaxial cable, exposed portions of the first and second conductors of the secondary twinaxial cable protruding from the secondary insulator, the secondary twinaxial cable including a secondary cable shield surrounding the secondary insulator to provide shielding for the first and second conductors of the secondary twinaxial cable;
a splice connector between the primary twinaxial cable and the secondary twinaxial cable to electrically connect the first and second conductors of the primary twinaxial cable with the first and second conductors of the secondary twinaxial cable, the splice connector including a contact assembly including a first contact and a second contact, the first contact being coupled to the exposed portions of the first conductors of the primary and secondary twinaxial cables, the second contact being coupled to the exposed portions of the second conductors of the primary and secondary twinaxial cables, the splice connector including an outer shell having a primary shroud forming a primary cavity receiving an end of the primary twinaxial cable, a secondary shroud forming a secondary cavity receiving an end of the secondary twinaxial cable, and a splice shroud forming a splice cavity receiving the contact assembly, the outer shell being electrically conductive, the primary shroud being electrically connected to the primary cable shield, the secondary shroud being electrically connected to the secondary cable shield.

24. The cable assembly of claim 23, wherein the outer shell has an inner surface at the primary shroud matching a shape of the primary cable shield to provide 360° connection to the primary cable shield and the outer shell has an inner surface at the secondary shroud matching a shape of the secondary cable shield to provide 360° connection to the secondary cable shield.

25. The cable assembly of claim 23, wherein the contact assembly includes a splice holder holding the first contact and the second contact.

26. The cable assembly of claim 23, wherein the outer shield includes splice windows aligned with the splice cavity to access the first and second contacts for joining the first and second conductors of the primary and secondary twinaxial cables with the first and second contacts.
